(19) United States
(12) Patent Application Publication
(10) Pub. No.: US 2015/0324831 A1
(43) Pub. Date: Nov. 12, 2015

(54) METHOD FOR PROCESSING CUSTOMER LOYALTY INFORMATION

(71) Applicants: Sonali BARUA, (US); Narayan NAMBUDIRI, (US)

(72) Inventors: Sonali Barua, Bangalore (IN); Narayan Nambudiri, Bangalore (IN)

(21) Appl. No.: 14/443,042

(22) PCT Filed: Nov. 11, 2013
(86) PCT No.: PCT/SG2013/000476

§ 371 Date: May 14, 2015

(30) Foreign Application Priority Data
Nov. 14, 2012 (SG) 201208406-7

(51) Int. Cl. G06Q 30/02; H04W 4/02

(52) U.S. Cl. CPC G06Q 30/0226; G06Q 30/0222; H04W 4/02

(57) ABSTRACT

A method comprises a step of obtaining an identification code of a product, a step of receiving a physical location of the product from a buyer, a step of noting geographical locations seller(s) of the product in the vicinity of the physical location of the product, a step of comparing the geographical location with the physical location, and a step of recording a sales transaction of the product if the geographical location is away from the physical location more than a predetermined distance.

The present application relates to one or more methods for processing customer loyalty information. The application also relates to one or more devices for processing the customer loyalty information. The devices or methods may alternatively be termed as systems wherever appropriate.

The current application claims the priority of Singapore Patent Application with serial number of SG201208406-7 entitled “Method for Processing Customer Loyalty Information”, which was filed on 14 Nov. 2012. The Subject matter of the priority application is hereby incorporated entirely by reference.

In the current market place, a product manufacturer (e.g. a brand owner) sells its products through distributors or retailers who stock products from several manufacturers. These retailers may also stock and sell competing products. Consumers purchase products from the retailers. Since the brand owners do not sell their products directly to the consumers, they have no direct connection with their customers. A brand loyalty program rewarding the consumer for frequent and loyal purchase of products is usually carried out through retailers by means of discount coupons or by requiring the consumer to mail in a physical proof of purchase or proof of sale in the form of a cash receipt or a piece of the product packaging. This process of managing the brand loyalty program is cumbersome to the consumer and it discourages consumers' participation in such brand loyalty programs. The brand owners are also unable to gather complete information on consumer purchasing patterns, consumer feedback or other details regarding the purchasing transaction directly. Brand owners have to obtain this information from the retailers of their product, and in most cases the brand owners have to pay, the retailers for this information.

The present inventions aim to provide new, creative and useful systems, devices or methods for processing customer loyalty information automatically. Essential features of the inventions are provided by independent claims, whilst important features of the inventions are given by dependent claims.

According to a first aspect, the application provides a method for processing customer loyalty information automatically. The method comprises a step of obtaining an identification code of a product from a party of transaction (e.g. a buyer or seller) automatically, a step of noting a geographical location related to the product from the a party of transaction automatically, a step of receiving a physical location of the product from a party of transaction automatically, a step of noting possible geographical locations of sellers, retailers or other parties of the product in vicinity of the physical location of the product, a step of comparing the geographical locations of the party with the physical location of the product, and a step of comparing the geographical location with the physical location for authenticating a transaction of the product. The method may further include a step of recording or authenticating a sale or purchase transaction of the product if the physical location of the product is away from possible geographical locations of the seller(s) in the vicinity by more than a predetermined distance. Some of these steps may be exchanged in sequence. For example, the method alternatively provides the step of noting the possible geographical locations of the sellers in the vicinity of the physical location of the product before obtaining the identification code of the product. The term “product” may be interchangeably used with “service item”, such as airline ticket for travelling service item.

The identification code includes product serial number, model number, batch number, manufacturing date, expiry date, price, country of sale and other product identity related information that identifies or relates to the product, which may be machine-readable by an electronic reader or scanner. For example, the identification code can be in the form of linear barcode (e.g. EAN-8, EAN-13 per ISO/IEC 15420), matrix (2D) barcode (e.g. DataMatrix) or RFID chip/tag (Radio-frequency identification). Usually, the product identification code is attached to the packaging/box of a product or service brochure such that a machine reader (e.g. barcode scanner, RFID reader, optical character recognition (OCR) reader) can easily detect, read or scan the identification code such that each product or service, or every batch of products or service item can be recorded, tracked or traced by computing/electronic devices automatically. In practice, mass serialization occurs when manufacturers assign and mark each of their products with a unique identifier (e.g. Electronic Product Code) by using machine or human readable tags, labels or RFID chips (e.g. DataMatrix barcode or Electronic Product Code (EPC)).

The step of noting the geographical location(s) related to the product is sometimes executed or received electronically by assigning one or more addresses or items of location information according to one or more space-based satellite navigation systems. The address broadly includes country name, city name, street name, street number and unit/apartment number. The address may be directly entered into a computer system database. For example, an Internet Protocol address (IP address) of the computer system provides location information (country or city) of the computer system. The space-based satellite navigation systems include Global Positioning System (GPS) of USA, Global Navigation Satellite System (GLONASS) of Russia, Galileo positioning system of European Union, Compass (Beidou) navigation system of China, Indian Regional Navigational Satellite System, and other similar systems.

The step of noting a geographical location may alternatively be carried out by assigning one or more default addresses to the product or a customer loyalty program related to the product. For example, the default address includes a registered business address of a brand owner, a corporate office of country, a warehouse address of a manufacturer or a wholesaler, or a common address designated for the product or service items. The default address may be readily stored or instantly received by the seller (e.g. brand owner or manufacturer) in an electronic form (e.g. address in a Systems Application Programming as an Integrated Enterprise Resource Planner for effectively managing enterprises Money, Material, Manufacturing & Machines).

The step of receiving a physical location of the product from a buyer includes getting the physical location by telephone, mail (postal letter), facsimile, electronic mail, one or more mobile application software packages (mobile app). Clearly, the physical location received electronically will provide almost real-time update to personnel or computer servers for immediate action. Alternatively, the location of an electronic device (e.g. mobile phone) used by a person (e.g. buyer) can be determined (whether it is being used or not) automatically, by adopting a technique known as multi-lateration to calculate the differences in time for a signal to travel from the electronic device (e.g. cell phone) to each of several cell towers near the owner of the electronic device. As a further alternative, the movements of a mobile phone user can be tracked by the service provider. Both the SIM (Subscriber Identity Module) card and the handset (mobile phone) can be tracked. Some techniques used for locating the geographical location of the product from the seller may also be applicable to obtaining the physical location of the product from the buyer.

The step of comparing the geographical location of the seller/vendor/buyer with the current physical location of the product reveals the movement of the product. For example, if the geographical location of the seller and the physical location of the product are almost identical, the product is likely to be unsold, being on a shelf or in a warehouse of the seller. Conversely, if the seller's geographical location and the product's physical location differ by more than a specified range, such as 35 meters, the product is likely to have been sold, as it can be safely assumed to have been taken out of the seller's. A collection of various locations of a type of products also indicate the sales distribution pattern of this type of product.

The step of recording or authenticating a sales transaction of the product takes place if the geographical location of the retailer/vendor is away from the physical location by more than a predetermined distance, such as 48 meters. The predetermined distance may be configured to reflect actual geographical locations of buyers and sellers and the type of product. For product sales in a convenience shop, the product may be recorded as transacted (sold or purchased) if the geographical location of the seller is away from the physical location of the product and the buyer by 26 meters. However, for product sales in a supermarket having a large area, the product may only be recorded as transacted if the geographical location is 216 meters away from the physical location. The purchase transaction may be denied (not recorded) if multiple physical locations of the same product have been received from a buyer over a short period (e.g. with one hour). Moreover, the purchase transaction may be limited to being recorded only once for a particular product having the identification code.

The present method enables the seller (e.g. brand owner, manufacturer, service provider, wholesaler or retailer) of the product to track down or trace the product automatically. Since the steps of the method can be implemented by one or more computers or computing devices, the seller can easily record, analyze and take actions related to the product. For example, a seller can plot a distribution pattern of the product to prevent excessive storage of this type of product at a particular warehouse.

In one situation, the step of noting the geographical location of a party (buyer, seller, shipping service provider, warehouse keeper) related to the product includes registering an address or location of a buyer. The registered address may be previously recorded by a seller when establishing the loyalty program related to the product, the buyer or both. If the physical location of the product matches with the geographical location, such as by scanning the product identifier or product unique identifier with a GPS enabled smartphone at the registered address (e.g. home) by the buyer, the transaction may be authenticated because the smartphone detected physical location is within the permissible range of the registered address, the registered address differing from the geographical location related to the product (corporate address of a brand owner, retailer).

In another situation, the step of noting the geographical location of a party related to the product includes getting a geographical position of the product from a seller (e.g. manufacturer, importer, logistic service provider, warehouse keeper, wholesaler, retailer, or any other party related to sales of the product). The geographical position can be subsequently compared with the physical location of the buyer. If the geographical location of the seller is away from the physical location of the buyer by a predetermined distance or range (e.g. 51 meters), the product may be authenticated, recognized and/or recorded as sold.

The method may further comprise a step of storing the identification information of the buyer. The identification information includes unique identities or personal profiles of their users/owners. The personal profiles or identifies/identifications are often referred to as personal data. The personal data, whether true or not, relates to an individual who can be identified from that data; or from that personal data and other information to which the organization has or is likely to have access. Examples of identification information include name, address, age, gender, contact telephone number, date of birth, account number/name (e.g. skype account name & credit card number) and other relevant information. The identification information may be stored in electronic form so that computing devices can automatically read, process or analyze the identification information. The step of storing also includes editing, changing, updating, correcting or other modification actions to the identification information, preferably by an authorized user. For example, the address of the buyer may be updated after relocation of the buyer after verification.

The method can further comprise a step of entering loyalty data according to the identification information of the buyer. Since the transaction can be uniquely associated with the buyer, the loyalty data may be recorded under the name or identification of the buyer. For example, certain loyalty points or credit notes (vouchers) may be dispatched to the buyer as rewards so that the buyer is encouraged to return for repeated purchase. The loyalty data further comprises shopping vouchers, discount cards, souvenirs, purchasing history, warranty information and product brochures, or cash credited to bank accounts. Keeping the loyalty data updated will keep the seller(s), manufacturer(s), or brand owner(s) in close communication with the buyer(s) such that the former can promptly respond to needs of the buyer.

The step of storing identification information may further comprise a step of registering an address of the buyer. The address of the buyer as registered may be a home address, office address, Postal Box address or other multiple addresses as identified by the buyer (e.g. longitude and latitude). Those addresses may be registered, recorded, updated or modified to keep up with the buyer's moves. The registered address may be in different languages as well, for easy identification.

The step of storing identification information can further comprise a step of communicating with a personal mobile communication device of the buyer. The personal mobile communication device includes portable electronic devices that can communicate with other communication devices via wired, near field communication (NFC) or far field communication (FFC) techniques, such as via USB, WiFi™, Bluetooth, 3G (third generation of mobile telecommunications technology), 4G (fourth generation of mobile telecommunications technology) and other electronic means. The communication may be encrypted, secured, or firewall or password protected. Examples of the personal mobile communication device includes mobile phone (cell phone), smartphone, tablet computer (e.g. iPad™). The personal mobile communication device is often used exclusively or personally such that the personal mobile communication device can carry the identification information of the user/owner/buyer.

The step of communicating may further comprise a step of obtaining the electronic identify of the personal mobile communication device. The electronic identity contains identify information readable by electronic devices. Particularly, the electronic identity includes the email address, Bluetooth MAC (Media Access Control) address, IMEI (International Mobile Station Equipment Identity), ICCID (Integrated Circuit Card Identifier) and biometric data (e.g. finger print record) of a user/buyer/device. With permission, an owner can allow transmission of his personal profile automatically and/or electronically to external parties when registering purchase, which helps avoid tedious manual correspondence with the retailers, whole sellers, manufacturers, service providers or brand owners.

The method can further comprise a step of identifying the location of the personal mobile communication device, possibly when receiving the physical location of the product from a buyer. The location of the personal mobile communication device can be determined by triangulation method of cellphone network, near field or far field methods (e.g. by Wi-Fi router or Access Point). In one case, the personal mobile communication device with a GPS receiver can receive Global Positioning System (GPS) signals to determine the device's location. The personal mobile communication device may provide latitude and longitude information, and sometimes also calculate altitude information. The location of the personal mobile communication device may be transmitted, verified and recorded as the registered address upon proper authorization of the buyer, the seller or both.

The method may also comprise a step of comparing the registered address of the buyer with the location of the personal mobile communication device for authenticating the purchase transaction. In one situation, the loyalty information may be updated if the registered address or the buyer is within a range (e.g. 32 meters) of the latitude and longitude given by the personal mobile communication device. The loyalty information or transaction may be denied or prevented from being recorded if the personal mobile communication device shows latitude and longitude differing drastically (e.g. 1 kilometers) from any of the previously registered addresses.

The method can further comprise a step of recording the location of the personal mobile communication device as a registered address of the buyer. Since accurate location (address, or latitude and longitude) may be transmitted by the personal mobile communication device, an authorized user of the personal mobile communication device (e.g. buyer) may instantly transfer information of the location to the seller for registering, updating, correction or modifying the recorded/registered address.

The method may further comprise a step of analyzing the purchasing behavior of the buyer. Since the product, transaction and loyalty information (e.g. purchasing history) can be uniquely associated with a buyer through the buyer's identification information (e.g. via the personal mobile communication device), interested parties (sellers or consultants) may analyze the buyer's purchasing history and personal profile to determine future offer prices, product features, quantities, etc. Collection of sales history of the type of product and personal profiles from many buyers may provide insight to the sellers for identifying potential new buyers, or future product trends.

The method can further comprise a step of sending information on products or services to the buyer. The information includes product service data, user manuals, promotion notices, vouchers, and government regulations about the product. The information, when sent electronically to the personal mobile communication device, can relieve the seller marketer, manufacturer or brand owner from posting a large number of postal mails, updating records or getting postal feedback from buyers.

The method may further comprise a step of evaluating selling patterns related to the product. The selling pattern (transaction records of large amounts of the products) can potentially afford insights to a seller regarding purchasing preferences related to different age groups, gender groups, income group, nationalities etc.

The method can further comprise a step of sending a voucher (credit note, loyalty point or other equivalents) to a personal communication device. Since the personal communication device is usually carried along by an individual, the individual can conveniently store several vouchers in the device when shopping. When coming near a shop selling products relevant to the vouchers, the personal communication device can automatically alert the individual for possible discount purchases. The shop or the individual can detect the proximity by the near field or far field communication techniques.

The present application provides a computer program encoding encoded with a set of computer instructions for processing customer loyalty information. The computer program that can run on a data processing system (computing device) is adapted to perform the above-mentioned method(s). The computer program may be installed on a local computer, several local computers connected by network(s), cloud (number of computers/servers connected through a real-time communication network), internet or intranet.

The present application further provides non-transient computer usable storage medium that have been encoded thereon data and computer instructions for processing customer loyalty information, for causing a data processing system to implement the above-mentioned methods. The non-transient computer usable storage medium relate to data storage device, electronic data storage, which can be magnetic, optical or electrical. Examples of the non-transient computer usable storage medium comprise hard disk drive, flash memory, CD-ROM (Compact Disc Read Only Memory) and DVD-ROM (Digital Optical Disc Ready Only Memory).

The application additionally provides a mobile application software package (i.e. mobile app (application)) that is encoded with a set of computer instructions for processing by non-transitory (non-transient) processors (e.g. personal mobile communication devices, mobile phones, smartphones). The mobile software package is configured to exchange information with a computer installed with computer programs. The mobile app, when installed on a mobile phone, greatly facilitates communication between a buyer and a seller, (manufacturer, brand owner, or loyalty program service provider).

According to a second aspect, the present application provides a method for processing customer loyalty information by a mobile communication device. The method comprises a step of scanning the unique identification code of a product; a step of receiving the physical location of a mobile communication device, and a step of electronically transmitting the unique identification code and the physical location to a remote/local server. Some of the steps may be exchanged in sequence. For example, the method may be performed by firstly receiving the physical location of a mobile communication device, which may be followed by scanning the unique identification code of a product by possibly using the mobile communication device. The method enables an authorized user (e.g. owner) of the mobile communication device to communicate the unique identification code of a product to a computer server remotely, electronically, instantaneously, automatically or in combination of any of these manners.

The method can further comprise a step of sending identification information of a buyer to the remote/local server. The identification information is conveniently stored and updated in an electronic form (softcopy) such that the identification information can be received by the remote server for automatic processing.

The method may further comprise a step of subscribing to a loyalty program related to the product. An authorized user of the mobile communication device can access an Internet website, an intranet page, mobile app or any other suitable applications such that the identification information stored or transmitted by the mobile communication device can avoid many manual procedures of filling forms, either in hard or softcopies. The subscription can be intelligently completed or assisted by the mobile communication device, thereby reducing human effort.

The method can further comprise a step of exchanging loyalty information with the remote server. The exchange of loyalty information includes updating the identification information (e.g. address), accumulating loyalty points, and receiving/sending electronic vouchers or alerts about the latest loyalty programs.

The application moreover provides a mobile application software package (mobile app) encoding a set of computer instructions for processing by a mobile communication device. When the mobile application software package runs on a data processing device (e.g. tablet computer), the mobile app is adapted to perform the above-mentioned methods. The mobile app can be widely accessed over the internet so that users/buyers worldwide will be able to access loyalty programs, which may have a common or standard platform for managing loyalty programs of one brand owner, or many brand owners.

According to a third aspect, the method provides a system or device for processing customer loyalty information. The system or device comprises a non-transient medium for keeping an unique identification code, and/or a geographical location of a product; a network interface module connected to the non-transient medium, the network interface being configured to receive notification of physical location of the product electronically, a digital (data/signal) processor (e.g. Central Processing Unit) connected to the non-transient medium and the network interface for comparing the geographical location with the physical location of the product; and an user interface module that is connected to the non-transient medium, the network interface and the computing processor for showing results of the comparison.

The non-transient medium includes materials or parts that are suitable for storing data, alternatively known as computer data storage. Materials that may be used for providing the medium contain magnetic or optical storage media. Hard disk drive, flash memory (solid state drives) and CD-ROM are suitable non-transient media. The network interface includes one or more gateways, routers, switches, bridges, hubs and repeaters. The network interface further includes one or more multilayer-switches, protocol converters, bridge routers, proxy servers, firewalls, network address translators, multiplexers, network interface controllers, wireless network interface controllers, ISDN (Integrated Services Digital Network) terminal adapters and line drivers. The digital processor includes a microprocessor, an application-specific processor, a graphics processing unit (Graphics Processing Unit/Visual Processing Unit), a physics processing unit (PPU), a digital signal processor, a network processor, a front end processor, a coprocessor, a floating-point unit, a data processing system, and the like.

The network interface can comprise a wired router, a wireless router or a wired & wireless integrated router for receiving notification of the physical location of the product via a computer network. The router may be assigned with an IP address and detect its distances from the personal mobile communication device when communicating. The router facilitates simultaneous communications from many personal mobile communication devices to one or more computer servers.

The network interface may comprise an antenna for receiving notification of the physical location of the product via a telecommunication network. The antenna may include one or more components for receiving radio signals of one or multiple bands. For example the antenna can pick up signals of the second generation (e.g. CDMA), third generation (e.g. UMTS TDD), fourth generation (e.g. LTE) and future generations. These bands may belong to GSM, IEEE802.16 (WiMAX), CDMA and IEEE802.20.

The user interface module can further comprise a printer for marking or printing the unique identification code onto the product. The user interface module may also include one or more keyboards, computer mice (mouse), styluses, touchscreens, LED Display/TVs and gesture recognition devices. The unique identification code can provide life-long identification information for tracking or following up on the product.

The accompanying figures (Figs.) illustrate embodiments and serve to explain the principles of the disclosed embodiments. It is to be understood, however, that these figures are presented for purposes of illustration only, and not for defining any limits of the relevant inventions.

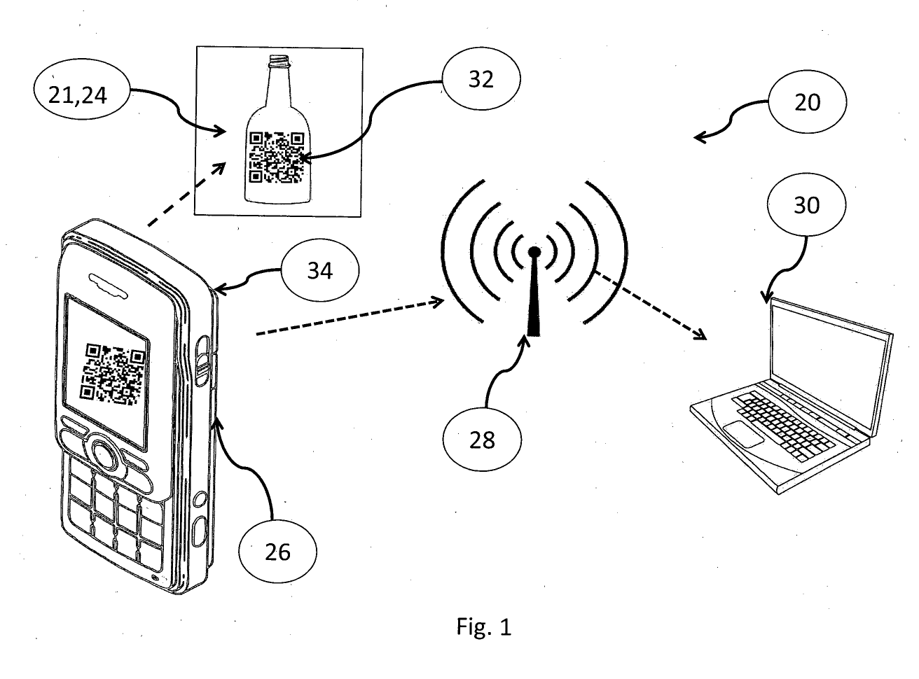

FIG. 1 illustrates a device for identifying a product and its geographical location;

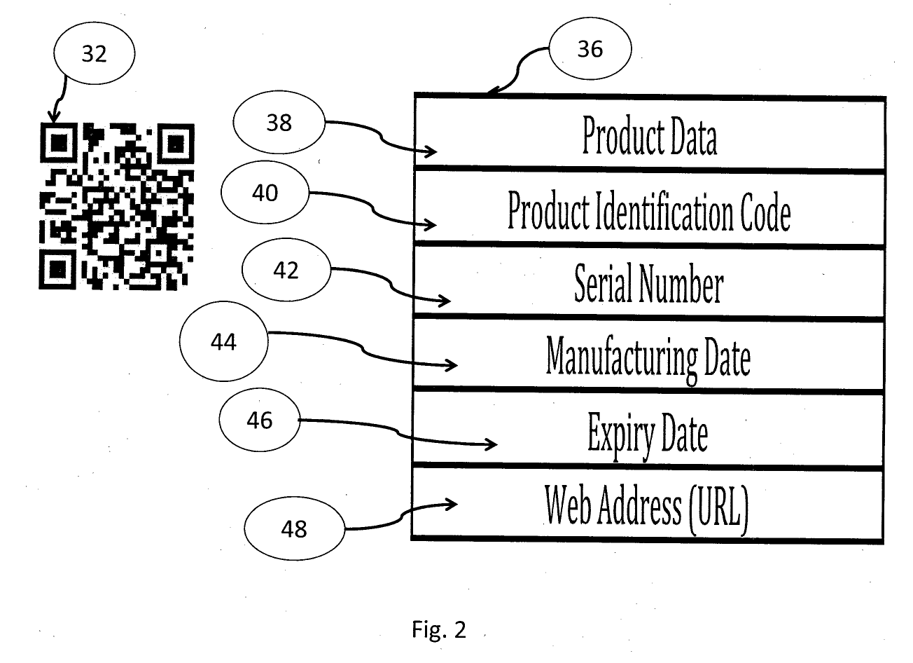

FIG. 2 illustrates a QR code containing the unique identification of the product;

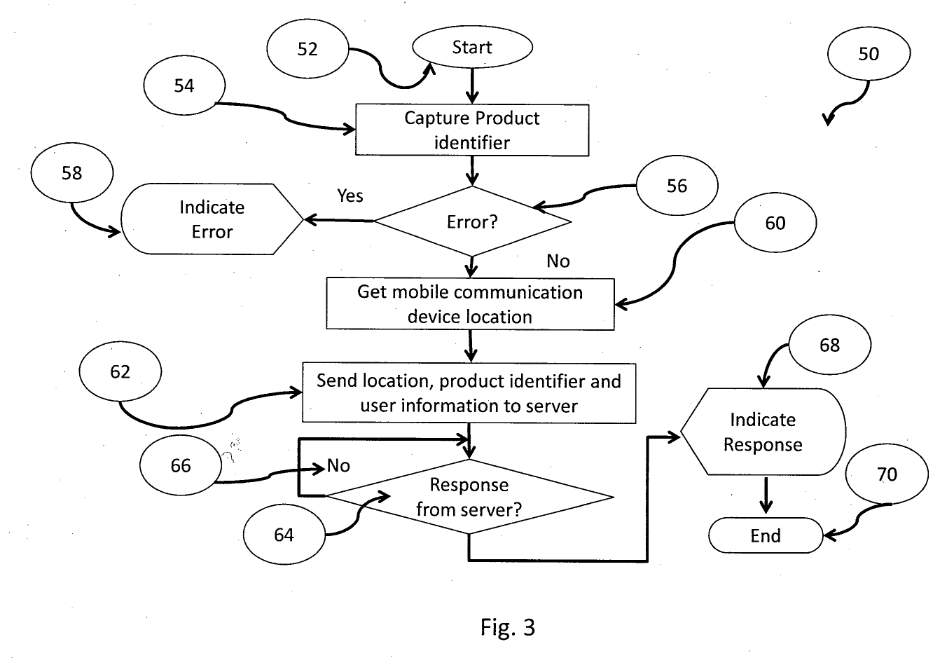

FIG. 3 illustrates a method for capturing identification information and geographical location of the product by a mobile communication device;

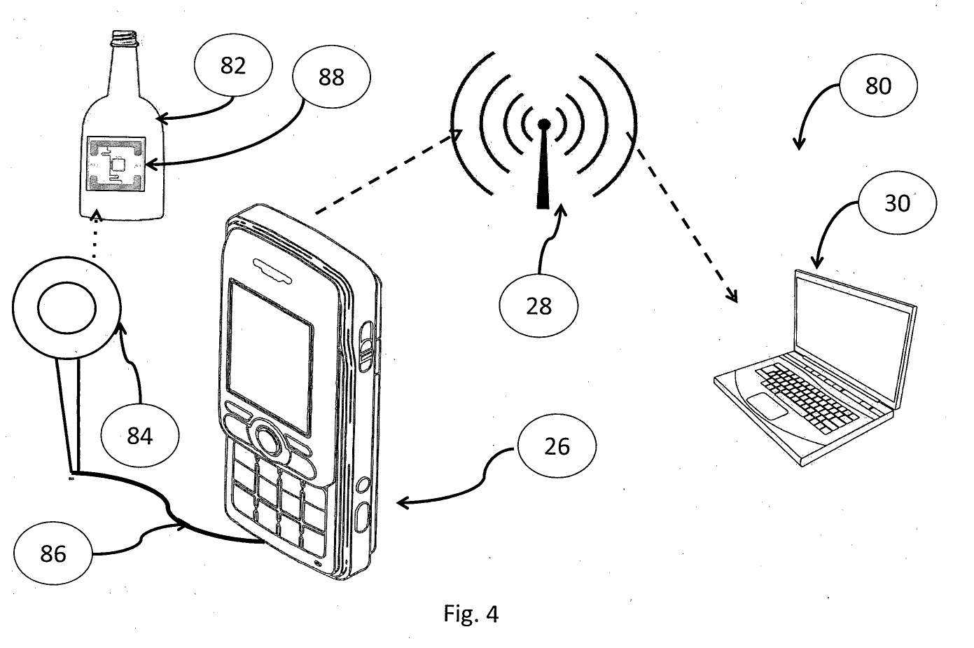

FIG. 4 illustrates an alternative device for acquiring identification of another product and geographical location of the other product; and

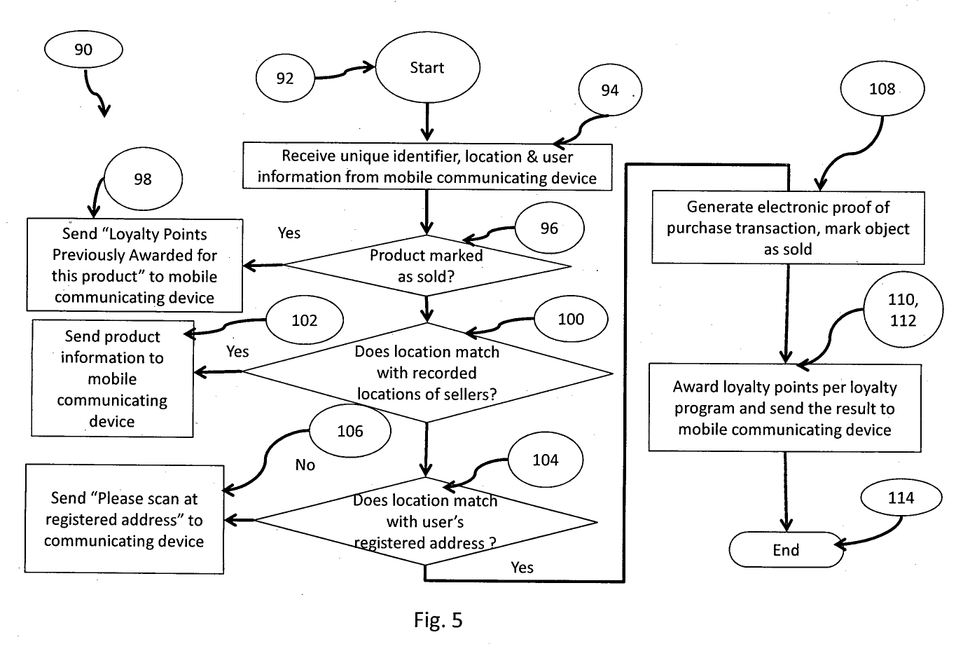

FIG. 5 illustrates a method for generating an electronic proof of purchase transaction of the product.

Exemplary, non-limiting embodiments of the present application will now be described with references to the above-mentioned figures. The embodiments may contain similar or identical parts that are labeled by similar or identical reference numerals. Description of the similar or identical parts is hereby incorporated by reference wherever relevant.

FIGS. 1 to 3 relate to a first embodiment of the application. In particular, FIG. 1 illustrates a device 20 for identifying a product 22 and its geographical location 24. The device 20 comprises the product 22, a mobile communication device 26, a telecommunication network 28 and a remote (computing) server 30. The product 22 further comprises a QR (Quick Response) code 32, whilst the mobile communication device 26 further comprises a barcode scanner/reader (camera) 34. The QR code 32 is a printed label that provides product identification or product unique identification.

FIG. 2 illustrates the QR code 32 of the product 22. According to FIG. 2, the QR code 32 provides identification information 36 of the product 22, which includes product data 38, product identification code 40, serial number 42, manufacturing date 44, expiry date 46, and website address (Uniform Resource Locator) 48. The QR code 32 is readable by a mobile app (not shown) on the mobile communication device 26 via the barcode scanner/reader 34 (camera). Alpha-numeric text data can thus be decoded for manual or automatic processing.

FIG. 3 illustrates a method 50 for capturing identification information 36 and geographical location 24 of the product 22 by the mobile communication device 26. The method 50 is presented in the form of a flow chart 50, which is executed by a mobile application initiated by the authorized user (not shown) on the mobile communication device 26. The authorized user initiates the method 50 by purchasing the product 22 from a retail shop (not shown). As he departs from the retail shop and arrives home, he switches on the mobile app (mobile application)—this is shown as the start step 52—and scans the QR Code 32, which is known as capturing identifier 54. The mobile communication device 26 detects 56 if an error occurs during the scanning. If the QR code 32 is soiled and the error does appear, the mobile communication device 26 displays 58 an error message so that the authorized user can take corrective actions, such as cleaning the QR code 32 for rescanning. If no error occurs, the mobile app extracts 60 geographical location (information) 24 of the mobile communication device 26. The geographical location 24 is obtained by utilizing the triangulation technique of cellphone network, a space-based satellite navigation system (e.g. Global Positioning System) and/or a WiFi router/access point. The mobile app further sends 62 the geographical location information 24, the product identification code 40 and the serial number 42 to the remote server 30, which is managed by a brand owner, or manufacturer or their agent (not shown) of the product 22. With permission from the authorized user, the mobile app further sends 62 user information (i.e. customer profile) to the remote server 30 via the telecommunication network 28 (e.g. 3G telecommunication network). The user information includes mobile phone number, registered address(s), age, gender and other relevant data. The remote server 30 receives and compares the user information and the geographical location information 24 with its records, and responds 64 to the mobile communication device 26 via the telecommunication network 28. If the mobile communication device 26 does not receive 66 response from the remote server 30, the mobile app will repeat the sending step 62 periodically (e.g. every 30 seconds). However, if the mobile communication device 26 does get the response, the mobile app will indicate 68 that the response has been successfully received, which validates the communication between the authorized user and the brand owner. The mobile app thus ends 70 its operation at the mobile communication device 26.

FIGS. 4 and 5 relate to a second embodiment of the application. Particularly, FIG. 4 illustrates an alternative device 80 for acquiring identification of another product 82 and geographical location of the other product 82. The alternative device 80 comprises a handheld RFID (radio-frequency identification) reader 84 and a cable 86 that connects the handheld RFID reader 84 to the mobile communication device 26. The alternative product 82 is embedded with a RFID chip/tag 88 in its packaging box.

FIG. 5 illustrates the method 90 for generating an electronic proof of purchase transaction by the remote server 30 for the product 22. The method 90 initiates 92 by activating the mobile app (not shown) that is configured to operate the camera/barcode reader 34. such that a product identification code 40 and serial number 42 which together uniquely identify product 22 (referred to as unique identifier) is acquired by the mobile communication device 26 and sent to the server 30 via the telecommunication network 28. At the same time, the mobile communication device 26 acquires electronic data that dynamically indicates its unique geographical location via the telecommunication network 28. The remote server 30 receives 94 electronic data packets that contain both the unique geographical location and the unique identifier 40 and 42. The remote server then checks its database to see if the unique identifier has been marked as previously sold. If so, the server sends an appropriate response 98 for e.g. “loyalty points have been previously awarded for this product” to the mobile communication device 26. The remote server 30 further compares 100 previously recorded addresses of the product sellers with the acquired unique geographical location in real-time. If the acquired unique geographical location is within 20 meters proximity of any of the recorded seller's addresses, the product 22 may still be inside a retail shop, thus the remote server 30 sends product information 102 to the mobile communication device 26.

If the acquired unique geographical location does not match with the registered buyer's (authorized user) address on record, the remote server 30 will convey another message 106 for e.g. “Please scan at the registered address” to the mobile communication device 26, and will not register sale of the product or issue loyalty points for the product 22. However, if the remote server 30 recognizes that the acquired unique geographical location coincides or matches with the address on record (e.g. registered address of the authorized user), it generates an electronic proof of purchase transaction and marks the product as sold 108. The remote server 30 further awards 110 loyalty points to the authorized user according to a predetermined loyalty program. The number of loyalty points is also communicated 112 to the authorized user, via the telecommunication network 28 to the mobile communication device 26. The mobile app thus terminates 114 its operation for the purchasing.

In the application, unless specified otherwise, the terms “comprising”, “comprise”, and grammatical variants thereof, intended to represent “open” or “inclusive” language such that they include recited elements but also permit inclusion of additional, non-explicitly recited elements. In the application, pronouns of singular or plural forms, such as “he”, “she”, “it”, “they”, “them”, “these” and “those”, may be interchangeably used, wherever appropriate.

As used herein, the term “about”, in the context of concentrations of components of the formulations, typically means +/−5% of the stated value, more typically +/−4% of the stated value, more typically +/−3% of the stated value, more typically, +/−2% of the stated value, even more typically +/−1% of the stated value, and even more typically +/−0.5% of the stated value.

Throughout this disclosure, certain embodiments may be disclosed in a range format. The description in range format is merely for convenience and brevity and should not be construed as an inflexible limitation on the scope of the disclosed ranges. Accordingly, the description of a range should be considered to have specifically disclosed all the possible sub-ranges as well as individual numerical values within that range. For example, description of a range such as from 1 to 6 should be considered to have specifically disclosed sub-ranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

It will be apparent that various other modifications and adaptations of the application will be apparent to the person skilled in the art after reading the foregoing disclosure without departing from the spirit and scope of the application and it is intended that all such modifications and adaptations come within the scope of the appended claims.

1. Method for processing customer loyalty information, the method comprising:
obtaining an identification code of a product,
noting a geographical location related to the product,
receiving a physical location of the product from a buyer, and
comparing the geographical location with the physical location for authenticating a transaction of the product.

2. Method of claim 1, wherein
The noting of geographical location comprises registering an address of a party to the transaction.

3. Method of claim 1, wherein
The noting of geographical location further comprises getting a geographical position of the product from a seller.

4. Method of claim 3 further comprising
Authenticating the transaction if the physical location of the product is away from the geographical location by more than a predetermined distance.

5. Method of claim 1 further comprising
Keeping identification information of the buyer.

6. Method of claim 5 further comprising
Entering loyalty data according to the identification information of the buyer.

7. Method of claim 5, wherein
The storing identification information further comprises communicating with a personal mobile communication device.

8. Method of claim 7, wherein
The communicating further comprises obtaining electronic identify of the personal mobile communication device.

9. Method of claim 7 further comprising
identifying a location of the personal mobile communication device.

10. Method of claim 9 further comprising
Comparing the registered address of the buyer with the location of the personal mobile communication device for authenticating the transaction.

11. Method of claim 9 further comprising
Recording the location of the personal mobile communication device as the registered address of the buyer.

12. Method of claim 5 further comprising
Analyzing purchasing behavior of the buyer.

13. Method of claim 5 further comprising
Sending information of the product to the buyer.

14. Method of claim 1 further comprising
Evaluating selling patterns related to the product.

15. Method of claim 1 further comprising
Sending a credit voucher to a personal communication device.

16. Computer program encoding a set of computer instruction for processing customer loyalty information, which when running on a data processing device is adapted to perform the method of claim 1.

17. Computer usable storage medium having encoded thereon data and computer instructions for processing customer loyalty information, for causing a data processing system to implement the method of claim 1.

18. Mobile application software encoding a set of computer instructions for processing by a non-transitory processor, for exchanging information with a computer installed with the computer program of claim 16.

19. Method for processing customer loyalty information by a mobile communication device, the method comprising:
Scanning an identification code of a product;
Receiving a physical location of the a mobile communication device, and
Transmitting the identification code and the physical location to a remote server electronically.

20. Method of claim 19 further comprising:
Sending identification information of a buyer to the remote server.

21. Method of claim 19 further comprising:
Subscribing to a loyalty program related to the product.

22. Method of claim 21 further comprising:
Exchanging loyalty information with the remote server.

23. Mobile application software encoding a set of computer instruction for processing by a mobile communication device, which when running on a data processing device is adapted to perform the method of claim 19.

24. System for processing customer loyalty information, the system comprising:
A non-transient medium for keeping an identification code, and/or a geographical location of a product;
A network interface module connected to the non-transient medium, the network interface being configured to receive notification of physical location of the product electronically,
A digital processor connected to the non-transient medium and the network interface for comparing the geographical location with the physical location of the product; and
An user interface module that is connected to the non-transient medium, the network interface and the computing processor for showing results of the comparing.

25. System of claim 24, wherein
The network interface comprises a router for receiving notification of physical location of the product via a computer network.

26. System of claim 25, wherein
The network interface comprises an antenna for receiving notification of physical location of the product via a telecommunication network.

27. System of claim 24, wherein
The user interface module further comprises a printer for marking the identification code onto the product.
